(19) United States
(12) Patent Application Publication
(10) Pub. No.: US 2011/0104649 A1
(43) Pub. Date: May 5, 2011

(54) System and method for preventing and treating repetitive stress injury

(76) Inventors: Judith Young, Regina (CA); Denny Rudy, Regina (CA)

(21) Appl. No.: 12/096,730

(22) Filed: Jun. 9, 2008

(30) Foreign Application Priority Data
Dec. 9, 2005 (CA) PCT/CA2005/001868

(51) Int. Cl. G09B 19/00

(52) U.S. Cl. 434/257

(57) ABSTRACT

A system and method for is disclosed that plays a video of a graphical representation of a person demonstrating a selected physical exercise that is aimed at preventing or treating a repetitive stress injury in one or more areas of the body. The video demonstrates the exercise in real time so that a user performing the exercise, in time with the demonstration, will perform the exercise in a proper period of time that increases the benefits of the exercise. The selected exercise could be either directly selected from a list of exercises, from a reduced list of exercises that focus or effect a specific body area chosen by the user, or one of a set of exercises. Alternatively, a scheduling event could be used to display a demonstration of a selected exercise upon the occurrence of a predetermined event.

This invention is in the field of systems and methods for the prevention and treatment of repetitive stress injuries and more particularly to system and method that provides a demonstration of physical exercises to prevent and treat repetitive stress injuries.

### BACKGROUND

Repetitive stress (or strain) injury (RSI) is caused by repeated movements of a portion of the body that causes stress or strain on a moving joint. Probably the best known form of RSI is Carpal Tunnel Syndrome or CTS, which often results from the excessive use of a keyboard. Through excessive use of a keyboard, CTS can occur when the tendons in a person's wrists become swollen and pinch nerves in the wrist causing pain and loss of movement. Typically, years of excessive and repetitive motions are required to cause RSI. In some cases, proper exercises and other treatments are successful at treating RSI, but in others, like extreme cases of carpal tunnel syndrome, surgery may be required to address the pain and potentially crippling effects of the disorder.

With the increasing use of keyboards and other technologies in the workplace, more and more people are using repetitive and limited movements with that result that RSIs are becoming more and more common. Not only is RSI uncomfortable and painful for the sufferer, but it can also causes losses to business by a loss of work and medical costs. RSIs accounts for a large percentage of work related illness in offices and other non-labour type occupations.

RSI often goes undetected until it achieves such a level that the injuries caused by RSI are irreversible. However, while it is caused by repetitive motions, it can minimized and even avoided by proper preventive exercise.

### SUMMARY OF THE INVENTION

It is an object of the present invention to provide a method and system that overcomes problems in the prior art.

In a first embodiment, the invention is a computer system for the prevention and treatment of repetitive stress injuries. The system comprises: a processing unit; a memory storage device operatively connected to the processing unit and containing a plurality of video files, each video file associated with a physical exercise and demonstrating a graphical representation of a person performing the physical exercise in real-time; an input device operatively connected to the processing unit wherein the input device is operative to transmit information to the processing unit; a display device operatively connected to the processing unit; and a program module stored in the memory storage device operative for providing instructions to the processing unit, the processing unit responsive to the instructions of the program module. The program module is operative for: identifying a selected physical exercise; responsive to identifying the selected exercise, accessing one of the plurality of video files in the memory storage device, the one of the plurality of video files being associated with the selected physical exercise; and displaying, on the display device, the video file, wherein the selected physical exercise is demonstrated by a graphical representation of a person in real-time and whereby a user can perform the physical exercise in time with the graphical representation of a person.

In a second embodiment, the invention is a method for the prevention and treatment of repetitive stress disorder. The method comprises: identifying a selected physical exercise; responsive to identifying a selected physical exercise, assessing a video file from a plurality of video files stored on a memory storage device; and displaying the contents of the video file on a display device. The video file is operative to demonstrate the selected exercise using a graphical representation of a person in real-time.

The invention, in one embodiment, is a program that is operative to run on a conventional computer system for preventing and treating repetitive stress injuries. The program displays a video of a graphical representation of a person demonstrating one of a number of different physical exercises aimed at preventing or treating repetitive stress injuries. The graphical representation of the person demonstrating the physical exercise could be a recording of an actual person doing demonstrating the physical exercise, an animation of a person doing the physical exercise or a video of the relative portions of a body completing the exercise. The video displays the person demonstrating the physical exercise in real time, taking the proper amount of time to complete the steps of the physical exercise that are recommended to achieve the best results from the physical exercise. For example, if a specific step of the physical exercise being demonstrated should be done over the space of 30 seconds for optimal results, the video will demonstrate that step being done over a 30 second period.

In this manner, a user can simply do the physical exercise, him or herself, in time with the person demonstrating it in the video. By following along with the person in the video, the user will perform the physical exercise in the recommended time and should achieve better and more consist results from the physical exercise.

The physical exercise that is displayed in the video can be selected in a number of ways. Firstly, the user can simply select the desired physical exercise from a list of all the exercises that are available. In this manner, a user is simply able to choose from a number of different physical exercises, which physical exercise he or she would like a demonstration of.

Alternatively, the user can select desired physical exercise to be demonstrated in the video by first choosing a specific body part that the user would either like to target or is bothering the user. In response to the user choosing a specific body part, a list of physical exercises that target or effect the body part is displayed and the user can choose a selected exercise from this reduced list.

The user can also choose a segment comprising a series of physical exercises, wherein choosing a segment will cause each of the series of physical exercises to be demonstrated in a video, one after the other. A user can either create their own segment made of a number of different exercises to be performed or use one of the predetermined segments comprising a number of different physical exercises, where the physical exercises have been selected to combine exercises for different parts of the body in a single segment.

Finally, a scheduling event can be used. The scheduling event is invoked when a triggering event occurs. The triggering event could be a specified time at a regular interval, such as weekly or daily basis, or the triggering event could be based on a period of use of the computer system, whereby when a user has been working on a computer system for a specified time, such as 2 hours, the triggering event will occur. In response to the occurrence of the triggering event, the scheduling event will perform an action. This action is either displaying a video demonstrating a specific physical exercise or invoking a segment comprising a number of physical exercises, wherein a number of videos are played, each video demonstrating one of the physical exercises, one after the other. In this manner, the physical exercises could be scheduled at regular periods to cycle through all of the physical exercises or the physical exercises could become more intensive as the time using a computer system accumulates.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is schematic illustration of a conventional computer system;

FIG. 2 is a screen shot of an interface, in accordance with the present invention;

FIG. 3 is a screen shot of a portion of the interface of FIG. 2, illustrating the control buttons on the interface;

FIG. 4 is a screen shot of a further interface, in accordance with the present invention, after a user has selected an exercise button;

FIG. 5 is a flowchart of an exercise selection process, in accordance with the present invention;

FIG. 6 is a screen shot of a further interface, after a user has selected an area button on the interface of FIG. 2;

FIG. 7 is a screen shot of a further interface, after a user has selected a body part on the interface of FIG. 6;

FIG. 8 is a flowchart of an area selection process, in accordance with the present invention;

FIG. 9 is a screen shot of a further interface, after a user has selected an area button on the interface of FIG. 2.

FIG. 10 is a flowchart of a segment process.

FIG. 11 is a screen shot of a further interface, after a user has selected a schedule button on the interface of FIG. 2, displaying a number of scheduling events.

FIG. 12 is a screen shot of a further interface where a triggering event can be specified by a user, based on a specified time on a daily basis, for invoking an action to be performed by the scheduling event;

FIG. 13 is a screen shot of a further interface where a triggering event can be specified by a user, based on a specified time on a weekly basis, for invoking an action to be performed by the scheduling event; and

FIG. 14 is a screen shot of a further interface where a triggering event can be specified by a user, based on a period of time a computer system has been used by user, for invoking an action to be performed by the scheduling event.

### DETAILED DESCRIPTION OF THE ILLUSTRATED EMBODIMENTS

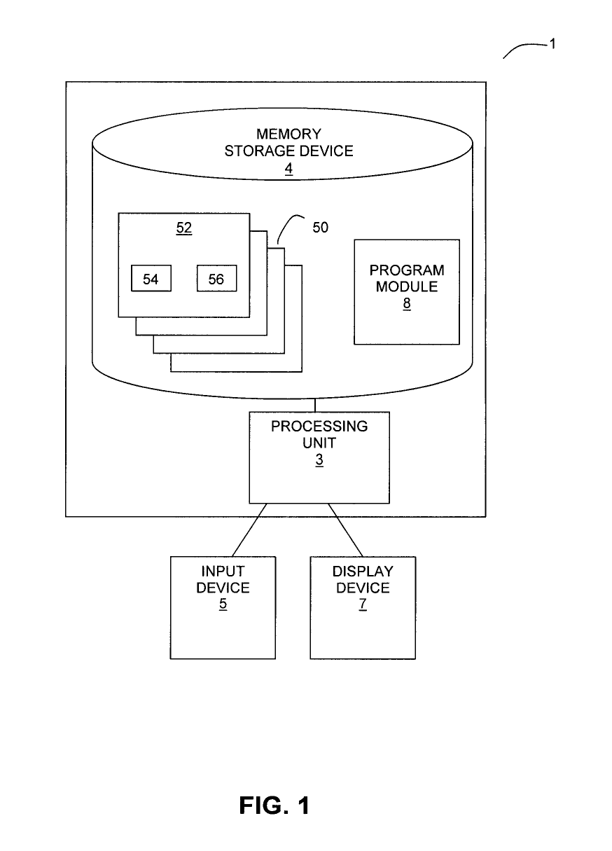

FIG. 1 illustrates a conventional computer system 1 suitable for supporting the operation of the method of the present invention. The conventional computer system 1 typically comprises: a processing unit 3; a memory storage device 4; an input device 5; a display device 7; and a program module 8.

The processing unit 3 can be any processing unit that is typically known in the art with the capacity to run the program and is operatively connected to the memory storage device 4. The memory storage device 4 is operative to store data and can be any storage device that is known in the art, such as a local hard-disk, etc. The input device 5 can be any suitable device suitable for inputting data into the computer system 1, such as a keyboard, mouse or data port such as a network connection and is coupled to the processing unit 3 and operative to allow the processing unit 3 to receive information from the input device 5. The display device 7 can be any suitable device coupled to the processing unit 3 and operative for displaying data. The program module 8 is stored in the memory storage device 4 and operative to provide instructions to processing unit 3 and the processing unit 3 responsive to the instructions of the program module 8.

Although other internal components of a computer system 1 are not illustrated, those of ordinary skill in the art will appreciate that many more components and interconnections between them are well known and can be used. As well the computer system 1 need not be limited to only one computer system and may comprise a network of connected computer systems.

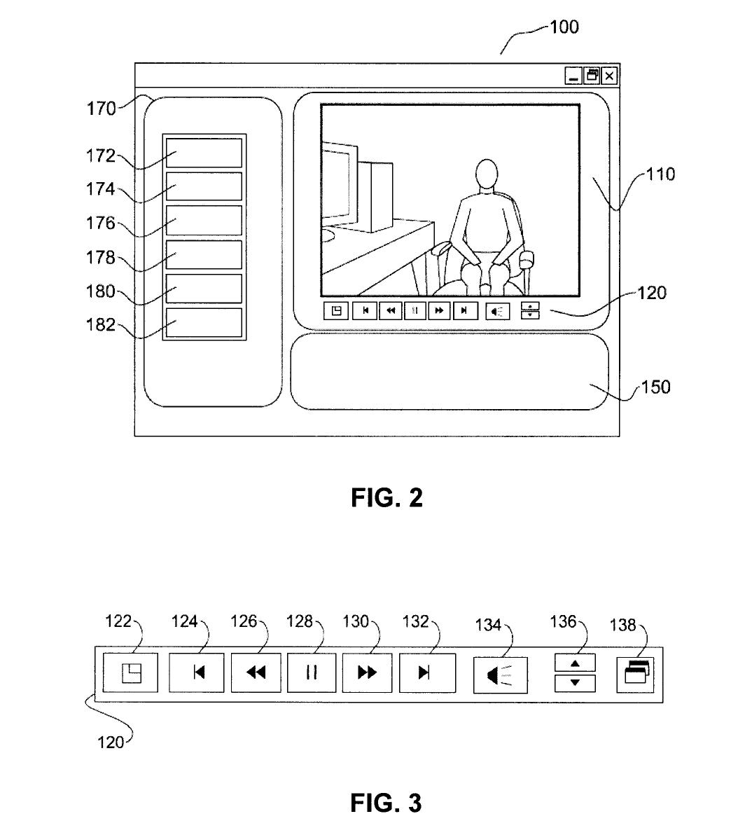

FIG. 2 is a screen shot of an interface 100 in accordance with the present invention. The interface 100 comprises: a viewing window 110; a row of control buttons 120; a caption box 150; and a row of main menu buttons 170.

The viewing window 110 is used to view videos and to display lists and other information that a user needs in order to use the interface 100.

The main menu buttons 170 comprise: an exercise button 172; an area button 174; a segments button 176; a schedule button 178; an options button 180; and a stats button 182. By selecting the exercise button 172, a user can choose a physical exercise from a list of exercises to be demonstrated by the program. By selecting the area button 174 a user can select a specific body part and see a list of exercises that are focused or effect the selected body part. By selecting the segments button 176 a user can select a segment made of a number of different exercises to be demonstrated. By selecting the schedule button 178 a user can view, edit and create a number of schedule events.

The caption box 150 displays text.

FIG. 3 is a screen shot of a portion of the interface 100 displaying the main menu buttons 120. The main menu buttons 120 comprise: an inset button 122; a restart video button 124; a view previous video button 126; a play and pause button 128; a view next video button 130; an end video button 132; a mute button 134; a volume toggle button 136; and a segment content button 138.

The inset button 122 is used to display inset alternative views for a video, if any are present in the video. The restart video button 124 restarts the present video that is playing the viewing window 110. The view previous video button 126 skips to a previous video if the video being displayed is part of a segment of videos. The play and pause video button 128 toggles between pausing the video, if a video is currently playing and playing a video, if the video is currently paused. The view next video 130 skips to a next video if the video being displayed is part of a segment of videos. The end video button 132 will end a video that is being played. The mute button 134 silences any audio that is being played in correspondence with the video and the volume toggle 136 will increase and decrease the volume of this audio. The segment content button 138 displays the contents of a segment if a video being played is part of a segment.

FIG. 3 is a screen shot of the interface 100, where the exercise button 172 has been selected by a user. The interface 100 displays an exercise list 210 in the viewing window 110. The exercise list 210 comprises all of the exercises 215 that are available for demonstration. Each exercise 215 will correspond to an actual physical exercise for use in the prevention of RSI. When a user highlights an exercise 215 in the exercise list 210, an exercise description 220 will appear in the caption screen 150 explaining the nature and any particulars of the exercise 215.

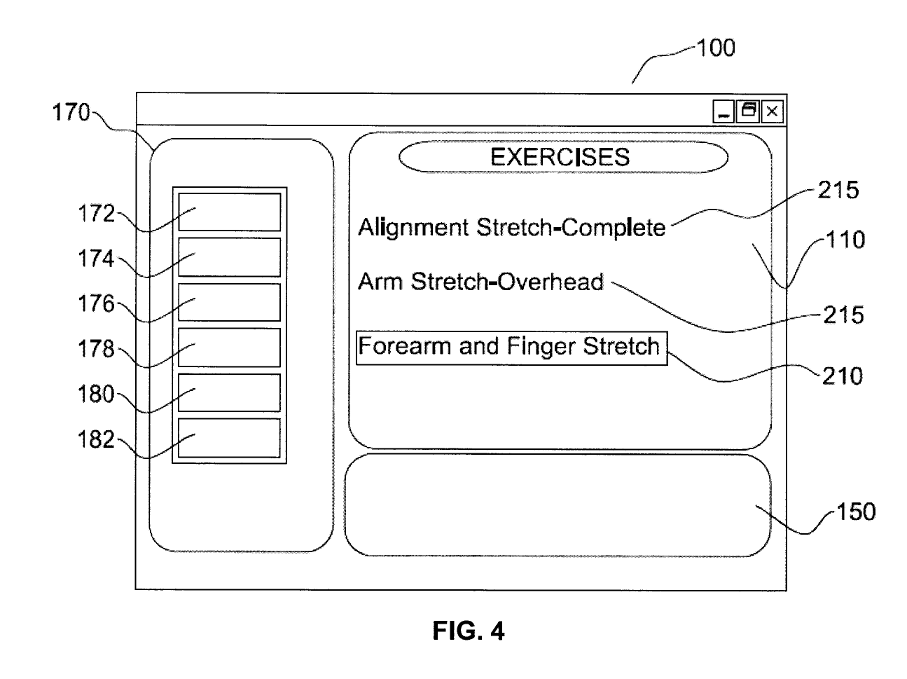

FIG. 4 is a flow chart of exercise selection process 250 that occurs when a user selects the exercise button 172 on the interface 100. The exercise selection process 520 starts 255 when a user selects the exercise button 172 on the interface 100 and comprises: displaying a list of available exercises 260; selecting an exercise 265; accessing a video file associated with the selected physical exercise 270; displaying the demonstration of the physical exercise stored in the video file 275; and ending 280.

The exercise selection process 250 starts when a user selects the exercise button 255. Referring to FIG. 3, the user selects the exercise button 172 on the interface 100 by typically using an input device and a cursor (not shown) to click the cursor on the exercise button 172.

Referring again to FIG. 4, a list of available exercises will be displayed to the user 260. Referring to FIG. 3, the viewing window 110 will display an exercise list 210. The user will typically use an input device (not shown), such as a mouse, to maneuver a cursor (not shown) over an exercise 215 in the list of available exercises 210. As the cursor is moved over an exercise 215, an exercise description 220 will appear in the caption box 150. This exercise description 220 will describe the exercise 215 and any particulars of the exercise 215. For example, the exercise description 220 could explain the benefits of the exercise 215 and the areas of the body that are targeted or effected by the exercise 215.

Referring again to FIG. 4, an exercise is selected 265. Referring to FIG. 3, a user selects one of the exercises 215 in the exercise list 210. The user typically makes this selection by clicking a cursor (not shown) on the exercise 210.

Referring again to FIG. 4, once an exercise is selected 265, a video file associated with the selected exercise is accessed 270. Referring to FIG. 1, a plurality of video files 50 will be stored in the memory device 4. Each video file 52 in the plurality of video files 50 is associated with a specific physical exercise, such as hand stretches, arm circles, etc. and each video file 52 contains a video clip that demonstrates the proper form and steps of the exercise associated with the video file 52. The video file 52 can be in MPEG, Quicktime, avi or any other suitable video format. The physical exercise is demonstrated by a graphical representation of a person performing the steps of the exercise in real-time with the graphical representation of a person taking the amount of time that is required to do each step of the physical exercise properly. In this manner, a user is able to follow along with the demonstration and for best results from the physical exercise, the user should do the physical exercise in time with the graphical representation of the person, taking the same amount of time to perform each step of the exercise that the graphical representation of the person in the video clip takes. The graphical representation of a person is of sufficient detail to allow a user to see how the physical exercise is performed and could be actual footage of a living person, animation of a complete person or simply an animation of the body parts that are relevant to the physical exercise.

Optionally, the video file 52 further comprises an audio portion 54 that explains the steps of the physical exercise as the graphical representation of the person demonstrates the steps.

Optionally, the video file 52 is associated with a text file 56 that is viewed in the content window 150 of the interface 100. As the graphical representation of the person demonstrates the steps of the physical exercise, text is displayed from the text file 56, in the caption window 150. The text describes the steps of the physical exercise as the graphical representation of a person demonstrates the steps.

Referring again to FIG. 4, once the video file, corresponding to the selected exercise is accessed 270, the video file will be played 275. Referring to FIG. 2, the video is played in the display window 110. As described above, the video contains a graphical representation of a person demonstrating a physical exercise. The video is played in real-time so that the steps taken by the graphical representation of the person demonstrating the physical exercise take the proper amount of time the steps of the physical exercise should be completed in to achieve proper results. A user can do the physical exercises being demonstrated by the physical representation of the person, following along in time with the demonstration and the steps of the physical exercise will then be completed in the proper amount of time to achieve increased benefits from the physical exercise.

Referring to FIGS. 2 and 3, a user can control the viewing of the demonstration of the physical exercise using the control buttons 120.

Referring again to FIG. 4, when the demonstration of the physical exercise is complete, the exercise selection process 250 ends 280.

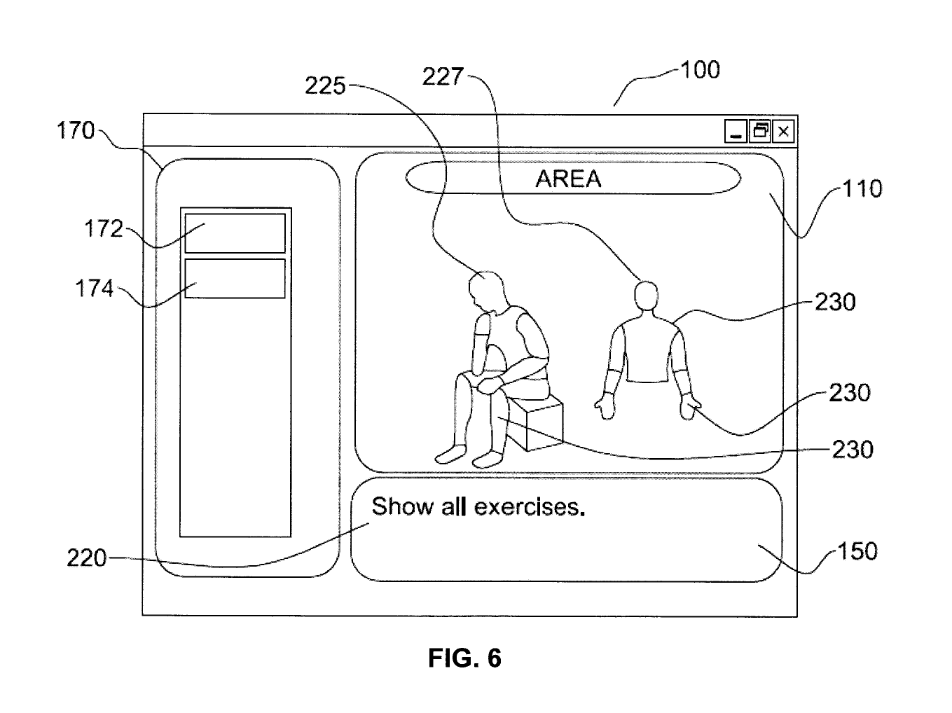

Referring again to FIG. 2, a user can also select the area button 174 rather than the exercise button 172. Selecting the area button 174 causes the interface 100 to change to the interface 100 shown in FIG. 6. FIG. 6 is an additional screen shot of the interface 100, where the area button 174 has been selected by a user. The interface 100 displays a first graphical representation of a body 225 and a second graphical representation of a body 227. Each of the first graphical representation of a body 225 and the second graphical representation of a body 227 comprises a number of body parts 230. By selecting a body part 230, the interface 100 changes to the interface 100 shown in FIG. 6. FIG. 6 is the interface 100 when a user has selected a body part 230. An exercise list 302 is displayed in the viewing window 110. Each of the exercises 215 in the exercise list 302 is associated with the body part 230 selected by the user and each exercise 215 will effect or focus on the selected body part 230. In this manner, a user can narrow down an exercise list 302 that only contains exercises 215 that a effect a specific body part 230 that the user wishes to focus on.

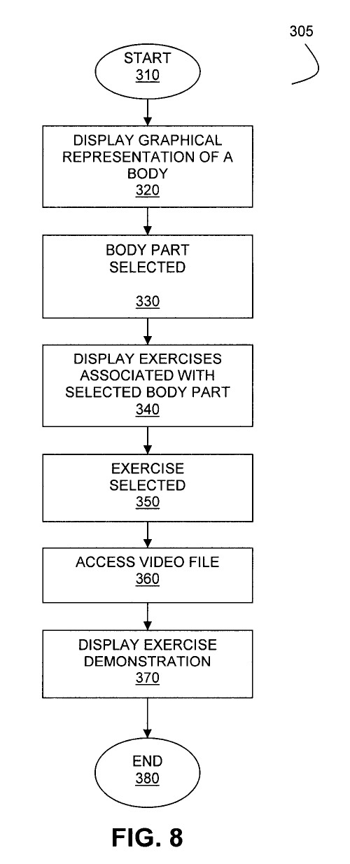

FIG. 8 is a flowchart of an area selection process 305 where a user can select a specific exercise based on a specific body part that a user would like to exercise or that is bothering the user.

The area selection process starts 310 when a user selects the area button on the interface. Referring to FIG. 2, the user selects the area button 174 from the main menu buttons 170 and the interface 100 changes to the interface 100 shown in FIG. 6. In FIG. 6, interface 100 displays a first graphically represented body 225 and a second graphically represented body 227. On this first and second graphically represented body 225, 227 various body parts 230 are shown wherein each of body parts 230 can be targeted with one or more physical exercises. Alternatively, the body parts 230 are also listed in the main menu buttons 170 and the user can see the body parts 230 as a list rather than graphically represented on the first or second graphically represented body 225, 227.

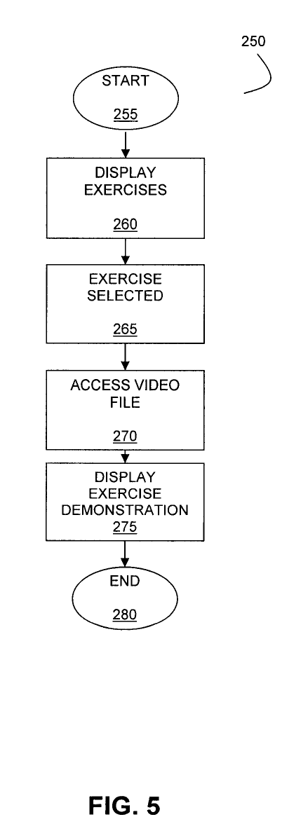

Referring again to FIG. 8, next a body part is selected 330, which the user would like to be exercised or which is causing the user some discomfort. Referring again to FIG. 5, the user uses an input device (not shown) to select one of the body parts 230 illustrates on either the first graphically represented body 225 or a second graphically represented body 227. Typically, the user will select the desired body part 230 by moving a cursor (not shown) over the displayed body part 230 and clicking on the body part 230.

Optionally, when a user moves the cursor over one of the body parts 230, a description of the body part 230 can be displayed in the caption box 150.

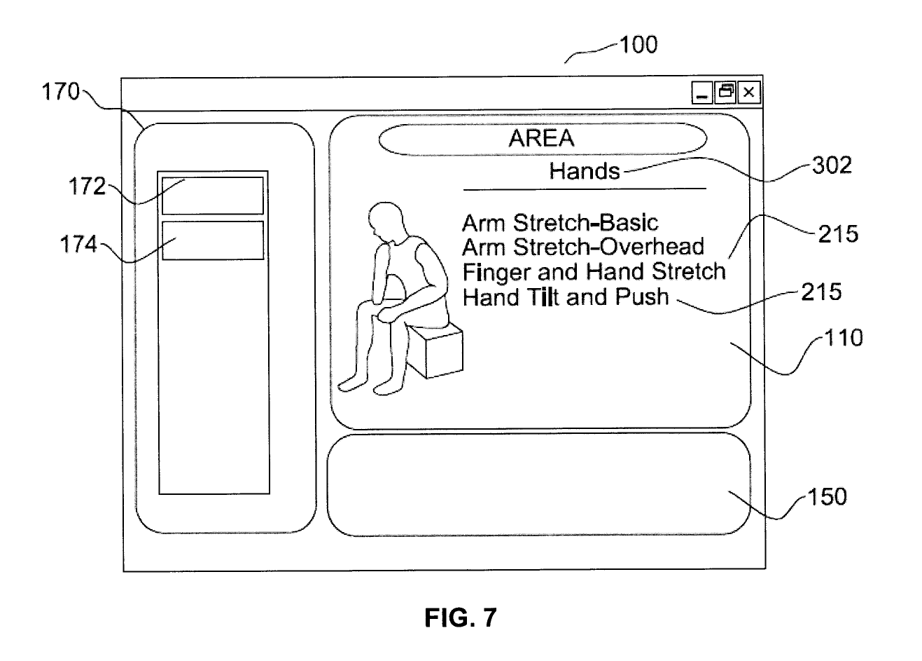

Referring again to FIG. 8, next a list of exercises associated with the selected body part is displayed 340. Referring to FIG. 7, an exercise list 302 is displayed in the viewing window 110 with each of the exercises 215 in the exercise list 302 focusing or effecting the selected body part 230. The user will typically use an input device, such as a mouse (not shown), to maneuver a cursor (not shown) over the exercises 215 in the exercise list 302. Optionally, as the cursor is moved over each of the exercises 215 an exercise description 220 will appear in the caption box 150 describing the exercise 215 and providing any particulars of the exercise 215. The user can typically select the desired exercise 215 by moving the cursor over the desired exercise 215 and clicking on the exercise 215.

Referring again to FIG. 8, once a physical exercise is selected 350, a video file associated with the selected exercise is accessed 360. Referring to FIG. 1, a plurality of video files 50 will be stored in the memory device 4. Each video file 52 in the plurality of video files 50 is associated with a specific physical exercise, such as hand stretches, arm circles, etc. and each video file 52 contains a video clip that demonstrates the proper form and steps of the exercise associated with the video file 52. The physical exercise is demonstrated by a graphical representation of a person performing the steps of the exercise in real-time with the graphical representation of a person taking the amount of time that is required to do each step of the physical exercise properly. In this manner, a user is able to follow along with the demonstration and for best results from the physical exercise, the user should do the physical exercise in time with the graphical representation of the person, taking the same amount of time to perform each step of the exercise that the graphical representation of the person in the video clip takes. The graphical representation of a person is of sufficient detail to allow a user to see how the physical exercise is performed and could be actual footage of a living person, animation of a complete person or simply an animation of the body parts that are relevant to the physical exercise.

Optionally, the video file 52 further comprises an audio portion 54 that explains the steps of the physical exercise as the graphical representation of the person demonstrates the steps.

Optionally, the video file 52 is associated with a text file 56 that is viewed in the content window 150 of the interface 100. As the graphical representation of the person demonstrates the steps of the physical exercise, text is displayed from the text file 56, in the caption window 150. The text describes the steps of the physical exercise as the graphical representation of a person demonstrates the steps.

Referring again to FIG. 8, one the proper video file is accessed 360, the video file will be played and the demonstration of the physical exercise will be demonstrated in the video 370. Referring to FIG. 2, the video is played in the display window 110. As described above, the video contains a graphical representation of a person demonstrating a physical exercise. The video is played in real-time so that the steps taken by the graphical representation of the person demonstrating the physical exercise take the proper amount of time the steps of the physical exercise should be completed in to achieve proper results. A user can do the physical exercises being demonstrated by the physical representation of the person, following along in time with the demonstration and the steps of the physical exercise will then be completed in the proper amount of time to achieve increased benefits from the physical exercise.

Referring to FIGS. 2 and 3, a user can control the viewing of the demonstration of the physical exercise using the control buttons 120.

Referring again to FIG. 8, when the process is completed the steps of the area selection process 305, the area selection process ends 380.

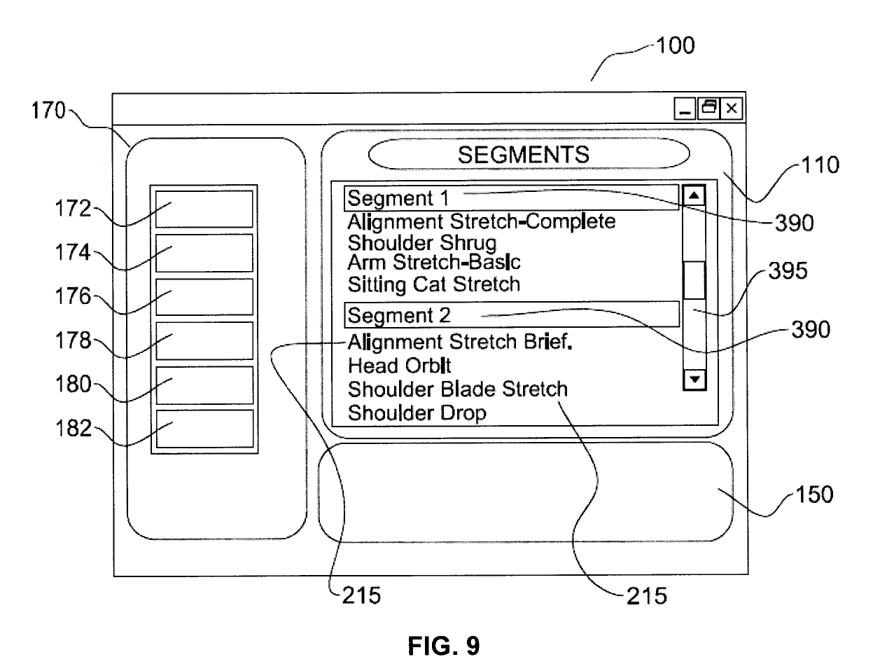

FIG. 9 is an illustration of the interface 100 after a user has selected the segments button 176. A plurality of segments 390 are shown in the display window 110. Each of the segments 390 comprises one or more exercises 215. The exercises 215, associated with each of the segments 390, are chosen so that a number of different body parts are exercised in each of the segments 390. In one embodiment of the invention each of the segments 390 is created by a person skilled in the art of treating RSI and the exercises 215 making up the segment 390 exercise various portions of the body. Alternatively, a user can create their own segment 390 by selecting the exercises 215 they would like to be included in their segment 390.

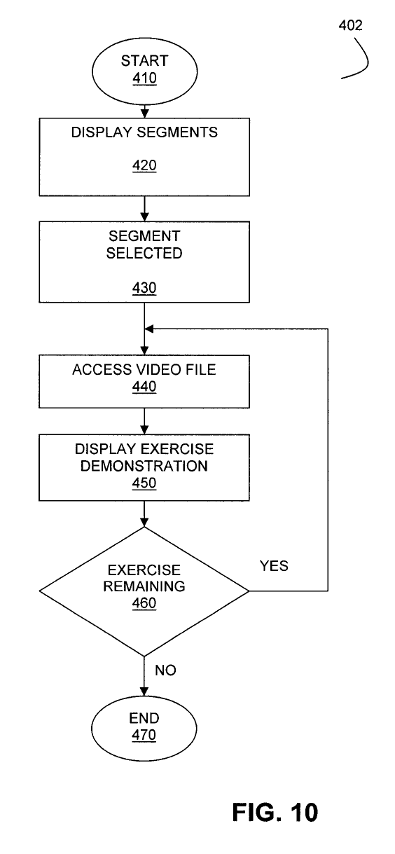

FIG. 10 is a flowchart of a segment process 402 that is used to display to a user demonstrations of each of the physical exercises contained in a segment. The process starts 410 when a user selects the segment button on the interface. Referring to FIG. 2, a user selects the segments button 176 on the interface 100.

Referring again to FIG. 10, after the process starts 410 a number of segments are displayed 420. Referring again to FIG. 9, a number of segments 390 are displayed in the viewing window 110 of the interface 100. A scroll bar 395 is used to scroll through the segments 390 if there are too many segments 390 to be viewed all together in the viewing window 110. Each of the segments 390 comprises one or more exercises 215 making up the segment 390.

Referring again to FIG. 10, one of the segments is selected 430. Referring again to FIG. 9, a user typically uses an input device (not shown) to move a cursor (not shown) to the segment 390 the user would like to select. To select a segment 390 a user uses the cursor to click on the segment 390.

Referring to FIG. 10, when a segment has been selected 430, a first video file is accessed 440. Referring to FIG. 8, each segment 390 comprises one or more exercises 215 making up the segment 390. When a segment 390 is selected a video file associated with the first exercise 215 in the segment 390 is accessed.

Referring to FIG. 1, a plurality of video files 50 will be stored in the memory device 4. Each video file 52 in the plurality of video files 50 is associated with a specific physical exercise, such as hand stretches, arm circles, etc. and each video file 52 contains a video clip that demonstrates the proper form and steps of the exercise associated with the video file 52. The physical exercise is demonstrated by a graphical representation of a person performing the steps of the exercise in real-time with the graphical representation of a person taking the amount of time that is required to do each step of the physical exercise properly. In this manner, a user is able to follow along with the demonstration and for best results from the physical exercise, the user should do the physical exercise in time with the graphical representation of the person, taking the same amount of time to perform each step of the exercise that the graphical representation of the person in the video clip takes. The graphical representation of a person is of sufficient detail to allow a user to see how the physical exercise is performed and could be actual footage of a living person, animation of a complete person or simply an animation of the body parts that are relevant to the physical exercise.

Optionally, the video file 52 further comprises an audio portion 54 that explains the steps of the physical exercise as the graphical representation of the person demonstrates the steps.

Optionally, the video file 52 is associated with a text file 56 that is viewed in the content window 150 of the interface 100. As the graphical representation of the person demonstrates the steps of the physical exercise, text is displayed from the text file 56, in the caption window 150. The text describes the steps of the physical exercise as the graphical representation of a person demonstrates the steps.

Referring again to FIG. 10, after the first video file is accessed 440, the video file is played and the physical exercise is demonstrated 450. Referring to FIG. 2, the video is played in the display window 110. As described above, the video contains a graphical representation of a person demonstrating a physical exercise. The video is played in real-time so that the steps taken by the graphical representation of the person demonstrating the physical exercise take the proper amount of time the steps of the physical exercise should be completed in to achieve proper results. A user can do the physical exercises being demonstrated by the physical representation of the person, following along in time with the demonstration and the steps of the physical exercise will then be completed in the proper amount of time to achieve increased benefits from the physical exercise.

Referring to FIGS. 2 and 3, a user can control the viewing of the demonstration of the physical exercise using the control buttons 120.

Referring again to FIG. 10, when the demonstration is completed 450 and another physical exercise is remaining in the selected segment 460, another video file, associated with the next exercise in the segment is accessed 440 and this next exercise is demonstrated to the user 450. As each video file is accessed 440 and the contents of the video file is displayed 450, as long as there is another exercise in the segment 460, each of the exercises in the segment will be demonstrated on after another. When there are no more exercises in the segment 460, the process will end 470.

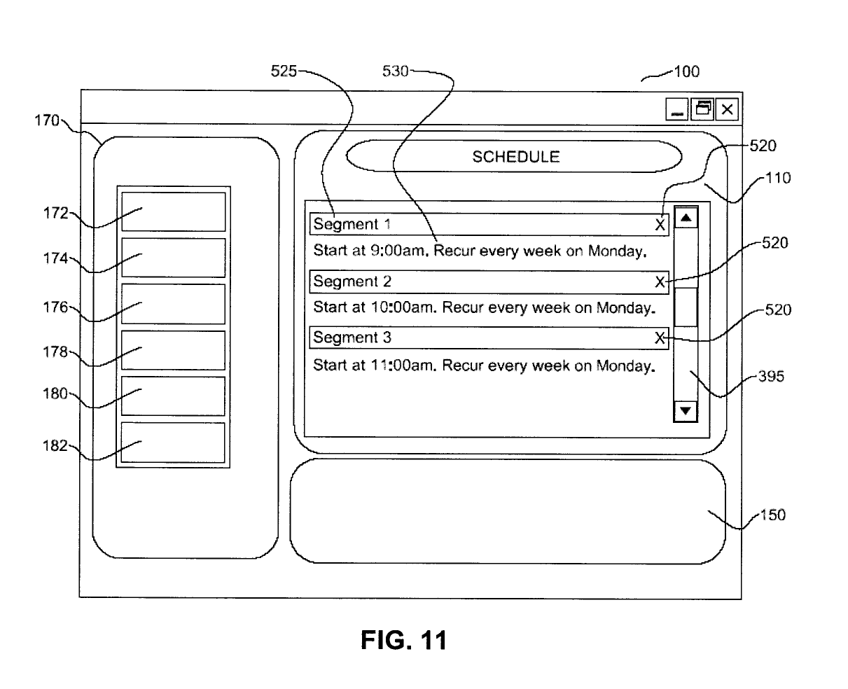

FIG. 11 illustrates a user interface 100 after a user has selected a schedule button 178. The interface 100 provides a number of schedule events 520 in the viewing window 110. Each scheduling event 520 includes an action 525 and a triggering event 530. The action 525 is performed when the triggering event occurs 530. The action 525 can be a selected segment comprising a series of exercises to be demonstrated a single selected exercise to be demonstrated.

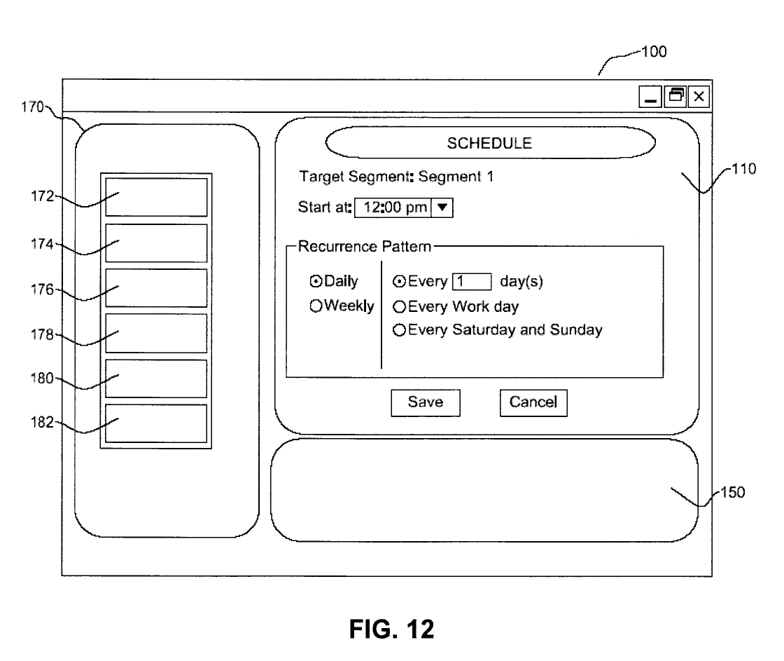

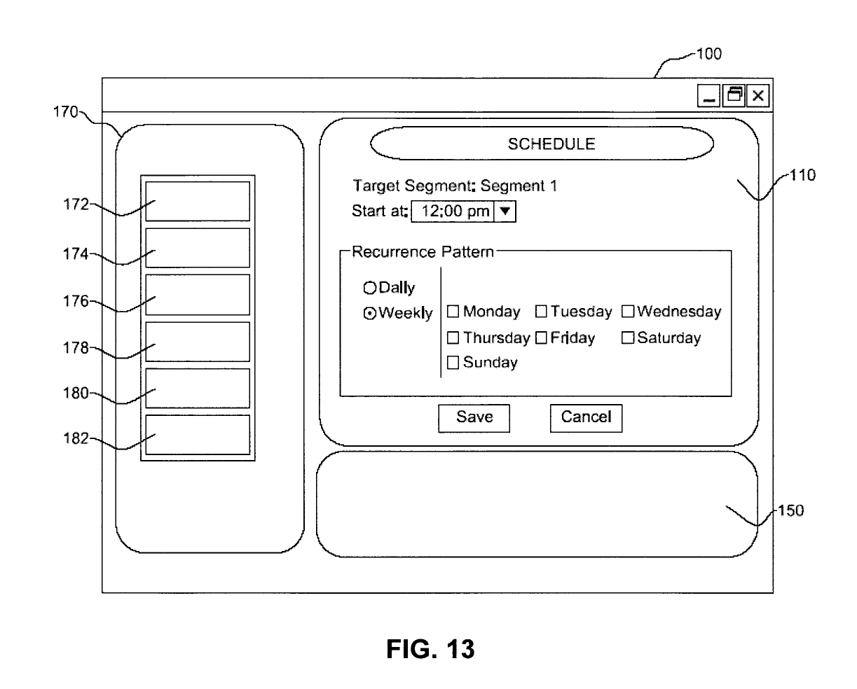

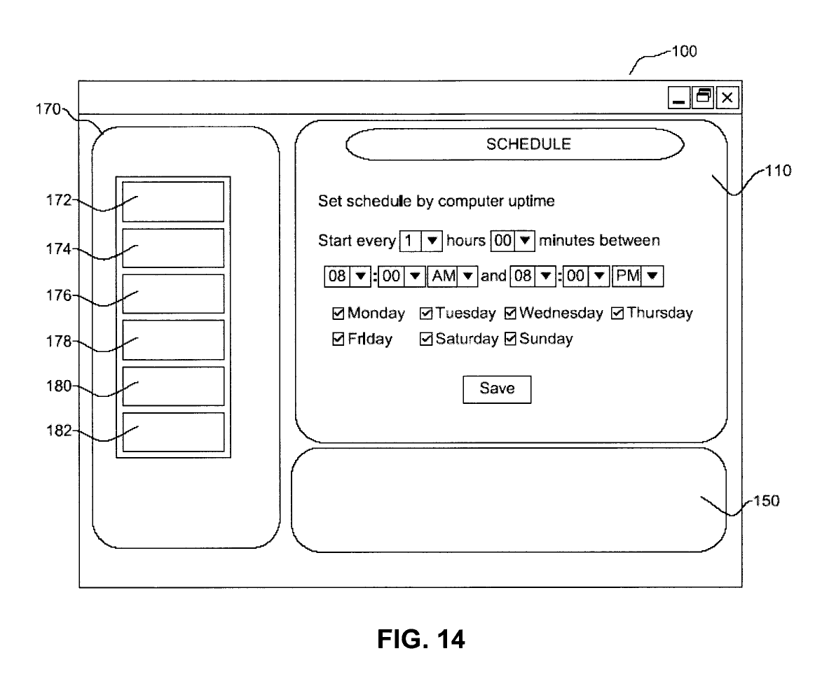

For each scheduling event 520, the action 525 is invoked, either starting the selected segment or the selected exercise, when the triggering event 530 occurs. The triggering event 530 could be time based, such as a set time on a daily or weekly basics. For example, FIG. 12 is a screen shot of the interface 100 where the triggering event 530 is a specified time on a daily basis, where the triggering event 530 occurs daily at the specified time. Additionally, FIG. 13 is a screen shot of the interface 100 where the triggering event 530 is a specified time on a weekly basis, where the triggering event 530 occurs weekly on a specified day of the week on a weekly basis. Alternatively, the triggering event 530 can be based on a predetermined period of use for the computer system. FIG. 14 is a screen shot of the interface 100 where the triggering event 530 is a specified period of time that the computer system has been used.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A computer system for the prevention and treatment of repetitive stress injuries, the system comprising:
a processing unit;
a memory storage device operatively connected to the processing unit and containing a plurality of video files, each video file associated with a physical exercise and demonstrating a graphical representation of a person performing the physical exercise in real-time;
an input device operatively connected to the processing unit wherein the input device is operative to transmit information to the processing unit;
a display device operatively connected to the processing unit; and
a program module stored in the memory storage device operative for providing instructions to the processing unit, the processing unit responsive to the instructions of the program module, the program module operative for:
identifying a selected physical exercise;
responsive to identifying the selected exercise, accessing one of the plurality of video files in the memory storage device, the one of the plurality of video files being associated with the selected physical exercise; and
displaying, on the display device, the video file, wherein the selected physical exercise is demonstrated by a graphical representation of a person in real-time and whereby a user can perform the physical exercise in time with the graphical representation of a person.

2. The computer system of claim 1 wherein the selected physical exercise is identified by receiving input from an input device and wherein a user has chosen the selected physical exercise from an exercise list.

3. The computer system of claim 1 wherein the selected physical exercise is identified by receiving a first input from the input device, wherein a user has chosen a selected body part and in response to choosing the selected body part, the processing unit displays an exercise list, the exercise list comprising one or more exercises related to the selected body part and receiving a second input from the input device, and wherein a user has chosen the selected physical exercise from the exercise list.

4. The computer system of claim 3 wherein the first input is provided by a user indicating the selected body part on a graphically represented body.

5. The computer system of claim 3 wherein the first input is provided by a user choosing the selected body part from a list of body parts.

6. The computer system of claim 1 wherein a segment comprises a plurality of physical exercises and the selected physical exercise is identified by being one of the physical exercises in the segment.

7. The computer system of claim 6 wherein the selected physical exercise is identified by being associated with a scheduling event that has been invoked by a triggering event.

8. The computer system of claim 1 wherein the triggering event is a specified time.

9. The computer system of claim 1 wherein the triggering event is a predetermined period of use of the computer system.

10. A method for the prevention and treatment of repetitive stress disorder, the method comprising:
identifying a selected physical exercise;
responsive to identifying a selected physical exercise, assessing a video file from a plurality of video files stored on a memory storage device; and
displaying the contents of the video file on a display device,
wherein the video file is operative to demonstrate the selected exercise using a graphical representation of a person in real-time.

11. The method of claim 10 wherein the selected physical exercise is identified by a user choosing the selected physical exercise from an exercise list.

12. The method of claim 10 wherein the selected physical exercise is identified by a user choosing a selected body part and then choosing the selected physical exercise from an exercise list, wherein the exercise list is displayed in response to the user choosing the selected body part.

13. The method of claim 10 wherein the selected body part is chosen by the user indicating the selected body part on a graphically represented body.

14. The method of claim 10 wherein the selected body part is chosen from a list of body parts.

15. The method of claim 10 wherein the selected physical exercise is identified by belonging to a segment of physical exercises, wherein each physical exercise will be demonstrated in series.

16. The method of claim 10 wherein the selected physical exercise is identified by being associated with a scheduling event and the scheduling event has been invoked by a triggering event.

17. The method of claim 10 wherein the triggering event is a specified time.

18. The method of claim 10 wherein the triggering event is a predetermined period of use of the computer system.

19. A computer readable medium having recorded thereon statements and instructions for execution by a computer to carry out the method of claim 10.
